(19) United States
(12) Patent Application Publication
(10) Pub. No.: US 2010/0033423 A1
(43) Pub. Date: Feb. 11, 2010

(54) Portable Electronic Apparatus and Input Operation Determining Method

(75) Inventor: Taro Iio, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto (JP)

(21) Appl. No.: 12/438,908

(22) PCT Filed: Jul. 30, 2007
(86) PCT No.: PCT/JP2007/064918

§ 371 Date: Oct. 7, 2009

(30) Foreign Application Priority Data
Aug. 25, 2006 (JP) 2006-229465

(51) Int. Cl. G09G 5/00

(52) U.S. Cl. 345/156

(57) ABSTRACT

A portable electronic apparatus 100 includes a plurality of sensor elements continuously and adjacently arranged, and a control unit 110 monitoring an operation state of a plurality of sensors. The control unit 110 is capable of detecting a single element detection state detecting an operation state in one sensor element out of a plurality of sensor elements, and an adjacent elements detection state detecting an operation state of two adjacent sensor elements out of the plurality of sensor elements, and determines an operation state by combination of the single element detection state and the adjacent elements detection state.

### TECHNICAL FIELD

The present invention relates to a portable electronic apparatus, and more particularly, to a portable electronic apparatus provided with a plurality of sensor elements which detect contact as an operation input unit.

### BACKGROUND ART

Conventionally, various interfaces and configurations have been developed as the operation input units of portable electronic apparatuses. For example, there is the art in which a rotary dial type input device is provided at a portable electronic apparatus, and a cursor displayed on a display unit is moved in accordance with the rotation quantity of the rotary dial type input device (see Patent Document 1). However, since in such a conventional art, “a rotary dial” with physical and mechanical rotation is used, a malfunction, a failure and the like easily occur due to mechanical wear and the like, and there are the problems that maintenance of the operation input units is required, and the service life is short.

Thus, there are proposed the arts of using touch sensors as the operation input units that do not involve physical and mechanical rotation (see Patent Documents 2 and 3). Each of the proposed arts arranges a plurality of touch sensor elements in a circular form, monitors contact detection from the individual touch sensor elements, and when detecting continuous contact detection, it determines that the instruction to move the display position occurs in correspondence with the movement of the contact detection spot.

### Patent Document 1: Japanese Patent Laid-Open No. 2003-280792

### Patent Document 2: Japanese Patent Laid-Open No. 2005-522797

### Patent Document 3: Japanese Patent Laid-Open No. 2004-311196

### SUMMARY OF INVENTION

### Technical Problem

As compared with the rotary dial input device shown in Patent Document 1, a malfunction, a failure and the like decrease in the case of the touch sensors shown in Patent Documents 2 and 3. However, in a portable electronic apparatus in which portability is essential, the size itself of the apparatus of the touch sensor is small, and dense layout is adopted. Therefore, when a user operates the touch sensor, the operation sometimes results in the operation which is not intended by the user. Therefore, a fine operation technique is demanded from the user, and an input technique at a higher level is sometimes imposed on the user.

The present invention has been made in view of such problems, and an object of the present invention is to provide a portable electronic apparatus which works as the operation intended by a user when a touch sensor is operated.

### Solution to Problem

In order to attain the above described object, a portable electronic apparatus of the present invention is characterized by including a plurality of sensor elements continuously and adjacently arranged, and a control unit monitoring an operation state of the the plurality of sensor elements, and characterized in that the the control unit is capable of detecting a single element detection state detecting an operation state in one sensor element out of the the plurality of sensor elements, and an adjacent elements detection state detecting an operation state in two adjacent sensor elements out of the the plurality of sensor elements, and determines an operation state by combination of the the single element detection state and the the adjacent elements detection state.

When the number of state transfers of the the single element detection state and adjacent elements detection state is one or two in the same direction which is an arranging direction of the the sensor elements, and the number of transfers from a first detection state is two or three, the the control unit preferably determines that an operation with movement occurs to the the sensor elements in the same direction which is the arranging direction of the the sensor elements.

Further, an input operation determining method of the present invention is characterized by including the step of monitoring an input operation state of a plurality of sensor elements continuously and adjacently arranged, and detecting a single element detection state detecting an operation state in one sensor element out of the the plurality of sensor elements, and an adjacent elements detection state detecting an operation state in two adjacent sensor elements out of the the plurality of sensor elements, and the step of determining an operation state by combination of the the single element detection state and the the adjacent elements detection state.

### Advantageous Effects on Invention

According to the present invention, in a portable electronic apparatus having touch sensor type operation means, operability as intended by a user with few malfunctions can be provided for a user.

### BRIEF DESCRIPTION OF DRAWINGS

FIG. 1 is a block diagram showing a basic configuration of a cellular phone terminal to which the present invention is applied;

FIG. 2 is a perspective view of the cellular phone terminal with sensor elements mounted on a casing;

FIG. 3 is a detailed functional block diagram of the cellular phone terminal to which the present invention is applied;

FIG. 4 is a block diagram showing a more detailed configuration of a touch sensor function of the cellular phone terminal according to the present invention;

FIG. 5 is a plane view showing the placement of the components of the cellular phone terminal according to the present invention;

FIG. 6 is an exploded perspective view of the components of the cellular phone terminal shown in FIG. 5;

FIG. 7 is a schematic block diagram explaining processing of contact detection data from each sensor element in the cellular phone terminal according to the present invention;

FIG. 8 is a diagram explaining the response of a sub display unit in the case of a user tracing the sensor elements;

FIG. 9 is a diagram explaining the response of the sub display unit in the case of a user tracing the sensor elements;

FIG. 10 is a conceptual diagram showing the sensor element detection state by dividing it into 16;

FIG. 11 is a flowchart showing one example of movement fixing processing (namely, holding processing) in the 16 detection states; and

FIG. 12 is a diagram explaining the fixing processing when the processing of the flowchart of FIG. 11 is applied to contact to the sensor elements L1 to L4 of FIG. 10.

### DESCRIPTION OF EMBODIMENTS

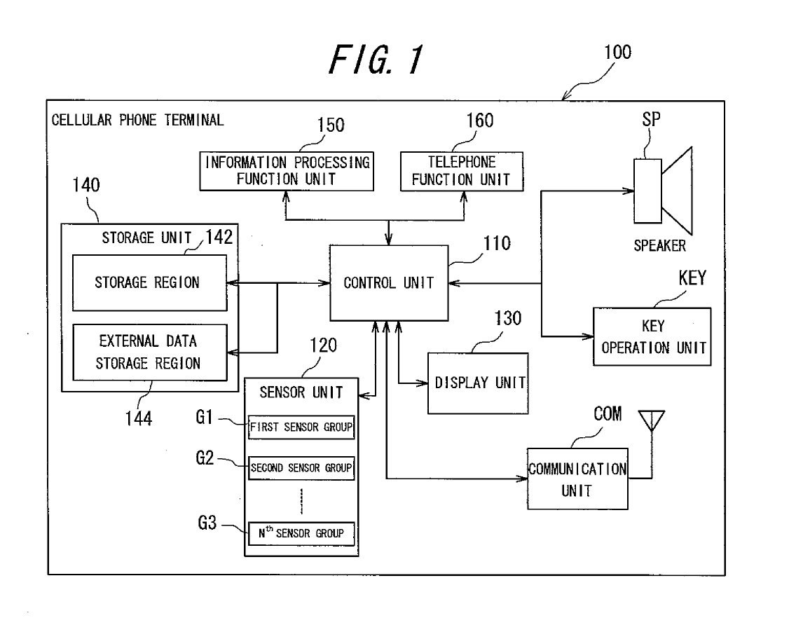

An embodiment of the present invention will be descried with reference to the drawings. Hereinafter, the present invention will be described by being applied to a cellular phone terminal as the typical example of a portable electronic apparatus. FIG. 1 is a block diagram showing the basic configuration of the cellular phone terminal to which the present invention is applied. A cellular phone terminal 100 shown in FIG. 1 is configured by a control unit 110, a sensor unit 120, a display unit 130, a storage unit (flash memory, or the like) 140, an information processing function unit 150, a telephone function unit 160, a key operation unit KEY and a speaker SP, and further, a communication unit COM which performs communication by being connected to a CDMA communication network not illustrated. Further, the sensor unit 120 includes n of sensor element groups including a plurality of sensor elements (for example, contact sensors having their detecting units provided on the outer surface of the apparatus casing, and detecting contact and approach of an object such as a finger) in accordance with a use purpose. That is, the sensor unit 120 includes a first sensor element group G1, a second sensor element group G2 and an n^{th} sensor element group G3, and the storage unit 140 is configured by a storage region 142 and an external data storage region 144. The control unit 110 and the information processing function unit 150 are preferably configured by calculating means such as a CPU, a software module, and the like. A serial interface unit SI which will be described later, an RFID module RFID and an infrared-ray communication unit IR which are connected to the control unit 110 via the serial interface unit SI, further, a camera 220 and a light 230, in addition to which, a microphone MIC, a radio module RM, a power supply PS, a power supply controller PSCON and the like are connected to the control unit 110, but they are omitted here for simplification.

The function of each block in the block diagram of FIG. 1 will be briefly described. The control unit 110 detects contact of an object by a finger or the like of a user by the sensor unit 120, stores the detected information in the storage region 142 of the storage unit 140, and controls processing of the stored information by the information processing function unit 150. Subsequently, the control unit 110 causes the display unit 130 to display the information corresponding to the processing result. Further, the control unit 110 controls the telephone function unit 160 for an ordinary call function, the key operation unit KEY and the speaker SP. The display unit 130 is configured by including a sub display unit ELD and a main display unit not illustrated (display unit which is provided at a position where it is hidden in the closed state of the cellular phone terminal 100, and is exposed in the opened state).

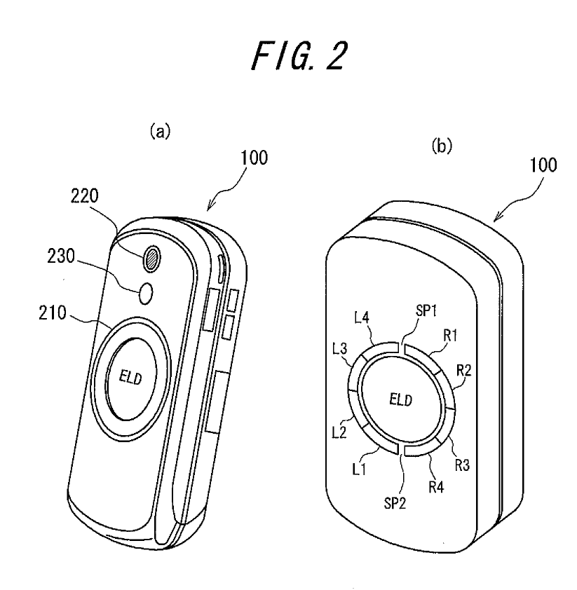

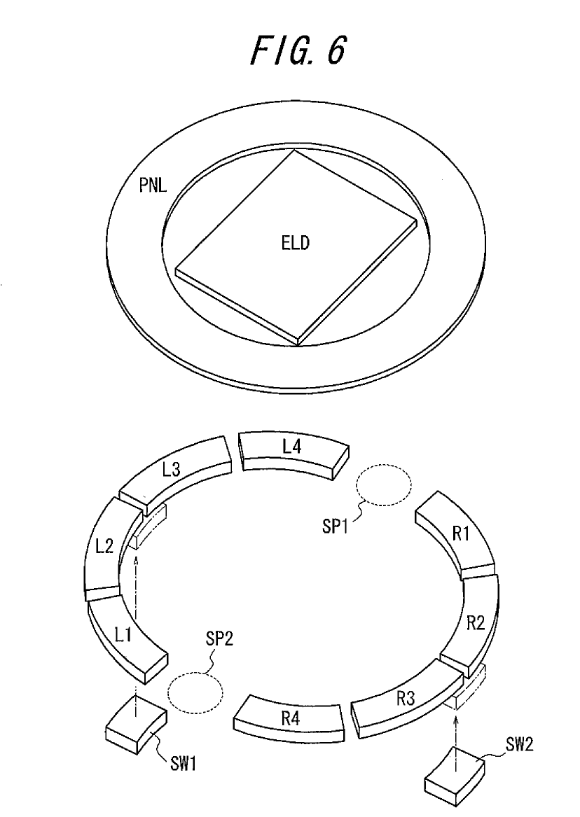

FIG. 2 is a perspective view of the cellular phone terminal with the sensor elements being mounted on the casing. The cellular phone terminal 100 is capable of forming an opened state by turning and sliding the hinge portion, in addition to the closed state as shown in FIG. 2, and a touch sensor unit 210 is provided at a position where it is operable even in the closed state. FIG. 2 (a) is a perspective view showing the appearance of the cellular phone terminal 100. The cellular phone terminal 100 includes the touch sensor unit 210 (in appearance, a panel PNL which covers the sensor unit 130, that is, the sensor element groups G1 and G2, and will be described later with FIG. 6 is seen), the camera 220, and the light 230. FIG. 2 (b) is a perspective view of the cellular phone terminal 100 showing only the placement of the sensor elements, the sub display unit ELD and its periphery by omitting the panel PNL for explanation of the operation of the touch sensor. As in the drawing, sensor elements L1 to L4 and R1 to R4 are placed side by side along the periphery of the sub display unit ELD. The sensor elements L1 to L4 configure the first sensor element group G1, and the sensor elements R1 to R4 configure the second sensor element group G2. The first sensor element group G1 and the second sensor element group G2 are arranged with separation sections SP1 and SP2 therebetween. With respect to the layout of the first sensor element group G1, the second sensor element group G2 has a layout of line symmetry with the direction in which the selection candidate items are arranged as a center line, with the sub display unit ELD therebetween. Further, in this configuration, an organic EL display is used for the sub display unit ELD, but, for example, a liquid crystal display or the like can be used. Further, an electrostatic capacitance type of contact sensor is used as the sensor element in this configuration, but a thin film resistor type contact sensor may be used.

In the cellular phone terminal 100 of FIG. 2, the sub display unit ELD displays the information corresponding to the use purpose of the cellular phone terminal 100. For example, when the cellular phone terminal 100 is used as a music player, the titles of pieces of music which can be played are displayed on the sub display unit ELD. The title, and the name of an artist of a piece of music constitute one item, that is, a “selection candidate item”. The user operates the touch sensor unit 210 as the operation input unit to change the electrostatic capacitances of the sensor elements L1 to L4 and R1 to R4, and moves the item and the operation target region displayed on the sub display unit ELD to select the title of a piece of music. At this time, if the touch sensor has a configuration in which the sensor elements are arranged around the sub display unit ELD as shown in FIG. 2, it does not have to occupy a large mounting portion in the outer casing of the compact portable electronic apparatus, and the user can operate the sensor elements while watching the display on the sub display unit ELD.

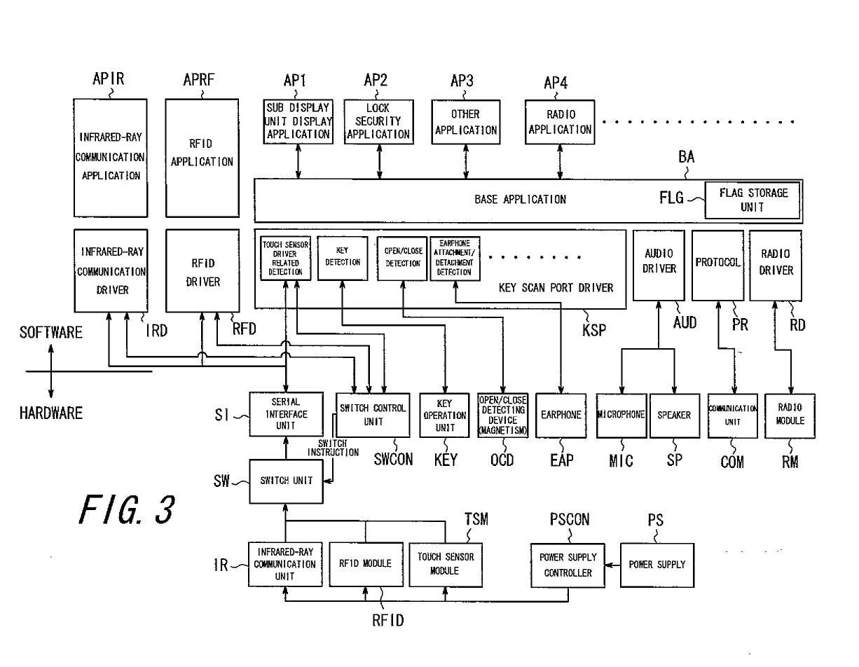

FIG. 3 is a detailed functional block diagram of the cellular phone terminal 100 to which the present invention is applied. Needless to say, various kinds of software shown in FIG. 3 are operated by being executed by the control unit 110 after a work area is provided on the storage unit 140, on the basis of the program stored in the storage unit 140. As shown in the drawing, the various functions of the cellular phone terminal are divided into a software block and a hardware block. The software block is configured by a base application BA having a flag storage unit FLG, a sub display unit display application AP1, a lock security application AP2, the other application AP3, and a radio application AP4. The software block further includes an infrared-ray communication application APIR and an RFID application APRF. When these kinds of applications (application software) control various kinds of hardware of the hardware block, an infrared-ray communication driver IRD, an RFID driver RFD, an audio driver AUD, a radio driver RD, and a protocol PR are used as drivers. For example, the audio driver AUD, the radio driver RD and the protocol PR control the microphone MIC, the speaker SP, the communication unit COM, and the radio module RM, respectively. The software block further includes a key scan port driver KSP which monitors and detects the operation state of the hardware, and performs detection related to the touch sensor driver, key detection, open/close detection detecting opening and closing of the cellular phone terminal of a folding type, a slide type or the like, earphone attachment/detachment detection and the like.

The hardware block is configured by the key operation unit KEY including a dial key, various buttons including tact switches SW1 to SW4 which will be described later, and the like, an open/close detecting device OCD which detects open/close based on the operation state of the hinge portion or the like, the microphone MIC accompanying the apparatus main body, a detachable and attachable earphone EAP, the speaker SP, the communication unit COM, the radio module RM, the serial interface unit SI, and a switch control unit SWCON. The switch control unit SWCON selects any one of the infrared-ray communication unit IR, the RFID module (radio recognition tag) RFID, and the touch sensor module TSM (what is formed by modularizing the sensor unit 120 and a set of components necessary for driving the sensor unit 120, such as an oscillation circuit) in accordance with the instruction from the corresponding block of the software block to switch the selection target hardware (IR, RFID, TSM) so that the serial interface unit SI picks up the corresponding signal. The power supply PS supplies power to the selection target hardware (IR, RFID, TSM) via the power supply controller PSCON.

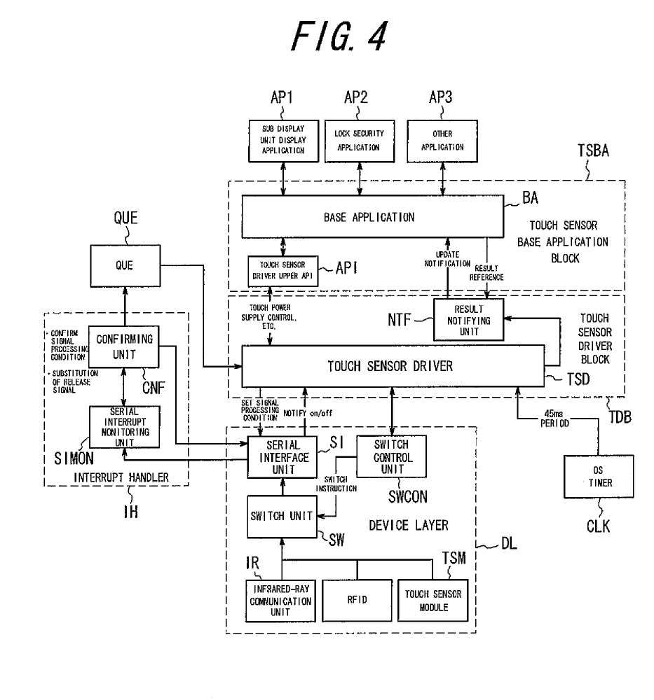

FIG. 4 is a block diagram showing a more detailed configuration of the touch sensor function of the cellular phone terminal 100 according to the present invention. As shown in the drawing, the cellular phone terminal 100 includes a touch sensor driver block TDB, a touch sensor base application block TSBA, a device layer DL, an interrupt handler IH, a queue QUEUE, an OS timer CLK, and various applications AP1 to AP3. Here, the touch sensor base application block TSBA includes a base application BA and a touch sensor driver upper application program interface API, and the touch sensor driver block TDB includes a touch sensor driver TSD and a result notifying unit NTF. Further, the device layer DL includes a switch control unit SWCON, a switch unit SW, the serial interface unit SI, the infrared-ray communication unit IR, the RFID module RFID and the touch sensor module TSM, and the interrupt handler IH includes a serial interrupt monitoring unit SIMON and a confirming unit CNF.

Next, the function of each of the blocks will be described with reference to the drawings. In the touch sensor base application block TSBA, exchange of the information of whether to actuate the touch sensor or not is performed between the base application BA and the touch sensor driver upper application program interface API. The base application BA is the application to be the base of the sub display unit display application AP1 which is the application for the sub display unit, the lock security application AP2 which is the application for locking the cellular phone terminal 100 for security protection, and the other application AP3, and requests the touch sensor driver upper application program interface API to actuate the touch sensor when the base application BA is requested to actuate the touch sensor from each of the the applications. The sub display unit is the sub display unit ELD shown in each of the drawings, and indicates the display unit provided in the central region of the sensor element groups placed in a circular form in the cellular phone terminal 100 in the present embodiment.

On receiving the request for actuation, the touch sensor driver upper application program interface API demands confirmation of whether actuation of the touch sensor is possible or not from a block (not illustrated) which manages actuation of the application in the base application BA. More specifically, the touch sensor driver upper application program interface API confirms lighting of the sub display unit ELD indicating that selection of the application is executed, or presence or absence of the flag which indicates actuation of the application in which actuation of the touch sensor being impossible is set in advance, of an FM radio or the other applications accompanying the cellular phone terminal 100. When actuation of the touch sensor is determined as possible as a result, the touch sensor driver upper application program interface API requests the touch sensor driver TSD to actuate the touch sensor module TSM. More specifically, the touch sensor driver upper application program interface API practically starts power supply to the touch sensor module TSM from the power supply PS via the power supply controller PSCOM.

When actuation is requested, the touch sensor driver TSD gives a request to the serial interface unit SI in the device layer DL to open the port with the touch sensor driver TSD in the serial interface unit SI.

Thereafter, the touch sensor driver TSD conducts control so that the signal having the information of the sensing result of the touch sensor (hereinafter, described as a contact signal) is output to the serial interface unit SI at the periods of 20 ms by the internal clock which the touch sensor module TSM has.

The contact signal is output as an 8-bit signal corresponding to eight sensor elements that are the aforementioned respective sensor elements L1 to L4 and R1 to R4. More specifically, this is the signal in which “flag: 1” indicating contact detection is set in the bit corresponding to the sensor element which detects the contact when each of the sensor elements detects the contact and the contact signal is formed by the string of these bits. More specifically, the contact signal includes the information indicating “which sensor element” is “either contact or non-contact”.

The serial interrupt monitoring unit SIMON in the interrupt handler IH extracts the contact signal output to the serial interface unit SI, Here, the confirming unit CNF confirms True/False of the contact signal which is extracted in accordance with the condition which is set in advance in the serial interface unit SI, and inputs only the data of a True (true) signal into the queue QUEUE (Discrimination of True/False of the signals will be described later). Further, the serial interrupt monitoring unit SIMON also monitors the other interrupt events of the serial interface unit SI during actuation of the touch sensor, such as occurrence of pressing down of the tact switch.

When the detected contact is the first contact, the monitoring unit SIMON inputs the signal meaning “press” into the queue QUEUE before the contact signal (queuing). Thereafter, the monitoring unit SIMON updates the contact signal at periods of 45 ms of the clock by an OS timer CLK which the operation system has, and inputs the signal meaning “release” into the queue QUEUE when it does not detect a predetermined number of contacts. Thereby, movement of the contact detection among the sensor elements from the start of the contact to release can be monitored. “The first contact” indicates the state without data in the queue QUEUE, or the event in which a signal having “flag: 1” occurs when the immediate input data is “release”. By these processing, the touch sensor driver TSD can know the detection state of the sensor elements in the section from “press” to “release”.

At the same time, when the contact signal which is output from the touch sensor is the signal which satisfies the condition to be False, the monitoring unit SIMON preliminarily generates a signal meaning “release”, and inputs it into the queue QUEUE. Here, as the conditions to be False (false), “when contact is detected in two sensor elements which are discontinuous”, “when interrupt occurs during actuation of the touch sensor (for example, when lighting/extinguishing state of the sub display unit ELD is changed by notification of the arrival of a mail or the like)”, “when push-down of the key occurs during actuation of the touch sensor”, “contact across a plurality of sensor element groups is detected” as will be described later, or the like is set.

Further, for example, when the monitor unit SIMON detects contact at the same time in the two adjacent sensor elements such as the sensor elements R2 and R3, it inputs the contact signal in which flags are set in the bits corresponding to the elements which detect contact into the queue QUEUE as in the case of detecting a single element.

The touch sensor driver TSD reads the contact signal from the queue QUEUE at the periods of 45 ms, and determines the elements which detect contact by the read contact signals. The touch sensor driver TSD considers change of the contact determined by the contact signals which are read in sequence from the queue QUEUE, and the positional relationship with the detected elements, and determines “the element of start of contact”, “detection of the moving direction (clockwise/counterclockwise direction) of contact” and “moving distance from press to release”. The touch sensor driver TSD writes the determined result into the result notifying unit NTF, and notifies the base application BA that the result should be updated.

The moving direction and moving distance of contact are determined by combination of detection of the adjacent sensor elements and detection of each of the sensor elements, and various methods (determination rules) can be applied to this (details will be described later). For example, when contact transfers from a certain sensor element (for example, R2) to the adjacent sensor elements (R2 and R3 in the case of this example), this is determined as the movement by the amount of one element (amount of one item in the sub display unit) in this direction.

As described above, when update of the result is notified to the base application BA by the touch sensor driver TSD, the base application BA confirms the result notifying unit NTF, and notifies the applications which are higher applications and require the touch sensor result (the display unit display application AP1 for menu screen display in the sub display unit, the lock security application AP2 for lock control, and the like) of the content of the information notified to the result notifying unit NTF.

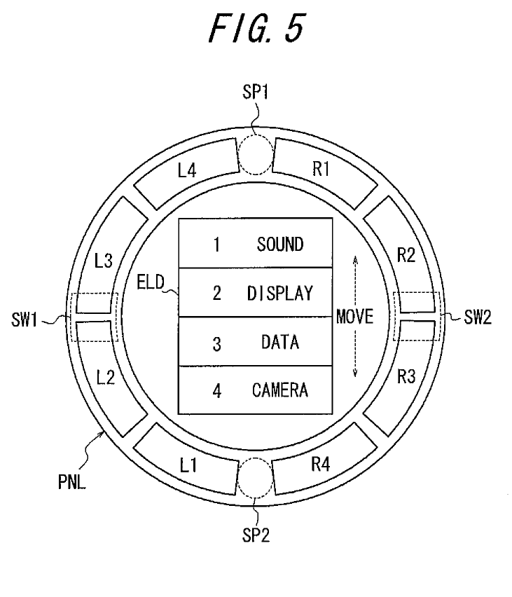

FIG. 5 is a plane view showing the placement of the components especially of the touch sensor unit 210 of the cellular phone terminal 100 according to the present invention. For convenience of creating the drawings and explanation, only some of the components are illustrated and explained. As shown in FIG. 5, the circular panel PNL is placed along the periphery of the sub display unit ELD constituted of the organic EL element. The panel PNL is preferably made sufficiently thin so as not to have an influence on the sensitivity of the sensor elements provided in the lower portion. In the lower portion of the panel PNL, eight electrostatic capacitance type sensor elements L1 to L4 and R1 to R4 which can detect contact/approach of the fingers of a human body are placed in a substantially circular form. The four sensor elements L1 to L4 at the left side configure the first sensor element group G1, and the four sensor elements R1 to R4 at the right side configure the second sensor element group G2, respectively. Between the adjacent sensor elements in each of the sensor element groups, a clearance (gap) is provided and placed so that the adjacent sensor elements do not interfere with the contact detection function of each other. When the sensor elements of a type which do not interfere with each other are used, the clearance is not necessary. The separation section SP1 which is a clearance larger than the aforesaid clearance (for example, the length twice as long as or more) is provided between the sensor element L4 located at one end of the first sensor element group G1 and the sensor element R1 located at one end of the second sensor element group G2. The separation section SP2 is provided similarly to the separation section SP1 between the sensor element L1 located at the other end of the first sensor element group G1 and the sensor element R4 located at the other end of the second sensor element group G2. When the first sensor element group G1 and the second sensor element group G2 separately function, they can be prevented from interfering with each other by such separation sections SP1 and SP2.

The respective sensor elements of the first sensor element group G1 are placed in a circular arc form, and the center of the tact switch SW1 is placed in the center of the circular arc, that is, the lower portion between the sensor elements L2 and L3. Similarly, the center of the tact switch SW2 is placed in the center of the circular arc formed by the respective sensor elements of the second sensor element group G2, that is, the lower portion between the sensor elements R2 and R3 (see FIG. 6). By placing the tact switches in substantially the center in the placement direction of the sensor element groups, which is the position that is not suggestive of the directionality like this, the user can easily grasp that the tact switch is the switch for performing operation which is not directly related to the direction indication by the movement indication operation having the directionality of the finger by the user on the sensor element. If the tact switch is placed at the end portion (for example, L1 or L4) instead of the center in the placement direction of the sensor element group, the tact switch is suggestive of the directionality toward the end portion side, and it easily gives the user misunderstanding that the tact switch is the “switch” to be pressed long to continue the moving operation by the touch sensor. Meanwhile, if the tact switch is placed in the center in the placement direction of the sensor element group as in the configuration of the present invention, such misunderstanding can be prevented, and a more comfortable user interface can be provided. Further, the tact switch is placed below the sensor element, and is not exposed to the outer surface of the apparatus. Therefore, the number of the operation units which are exposed can be reduced in appearance of the apparatus, and gives a smart impression which does not require a complicated operation. When the switch is provided in the place other than the lower portion of the panel PNL, a through-hole needs to be additionally provided in the apparatus casing, and depending on the position where the through-hole is provided, reduction in casing strength may occur. In the present configuration, by placing the tact switches below the panel PNL and the sensor elements, new through-holes do not need to be provided, and reduction in casing strength can be prevented.

When a user traces the sensor elements L1, L2, L3 and L4 in sequence with, for example, a finger in a circular arc form in the upward direction, the item which is displayed as the selection target region (reversing display, highlighting display in another color or the like) out of the selection candidate items (sound, display, data, and camera in this case) displayed on the display unit ELD, sequentially changes to the upper item, or the selection candidate item is scrolled in the upper direction. When a desired selection candidate item is displayed as the selection target region, the user can perform a selection determination by pressing down the tact switch SW1 through the panel PNL and the sensor elements L2 and L3, and can change the display itself to another screen by pressing down the tact switch SW2. Specifically, the panel PNL has sufficient flexibility for pressing down the tact switches SW1 and SW2, or is mounted to the apparatus casing to be slightly tiltable, and has the role of a plunger for the tact switches SW1 and SW2.

FIG. 6 is an exploded perspective view of the component, especially the touch sensor unit 210, of the cellular phone terminal shown in FIGS. 2 and 5. As shown in the drawing, the panel PNL and the display unit ELD are placed on the first layer forming the outer surface of the terminal casing. The sensor elements L1 to L4 and R1 to R4 are placed on the second layer located below the panel PNL on the first layer. The tact switches SW1 and SW2 are placed respectively on a third layer located under a space between the sensor elements L2 and L3 of the second layer and under a space between the sensor elements R2 and R3.

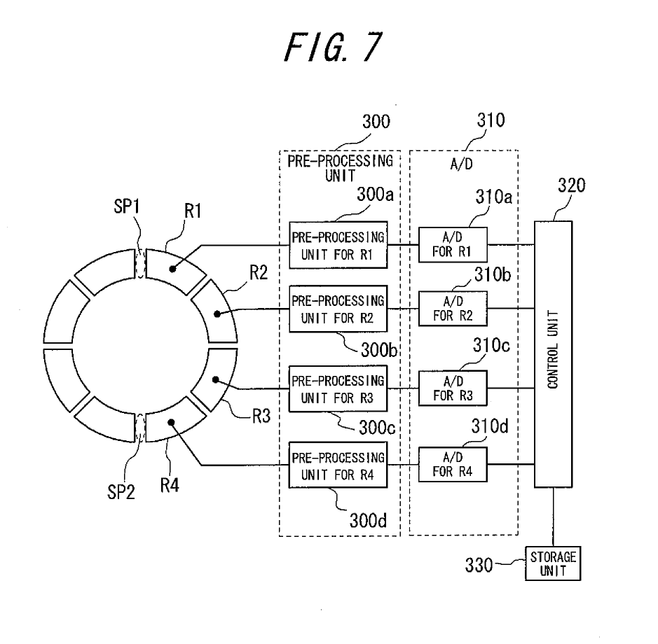

FIG. 7 is a schematic block diagram explaining the processing of the contact detection data from each of the sensor elements in the cellular phone terminal according to the present invention. For simplification of the explanation, only the sensor elements R1 to R4 are shown, but the same thing applies to the sensor elements L1 to L4. High frequency wave is applied to each of the sensor elements R1 to R4, calibration is performed with consideration being given to the change in a constant stray capacitance, the high frequency state at this time is set as the reference, and when variation in the high frequency state based on the change in the electrostatic capacitance by contact of a finger or the like is detected in a pre-processing unit 300 (a pre-processing unit for R1 300a, a pre-processing unit for R2 300b, a pre-processing unit for R3 300c, a pre-processing unit for R4 300d), detection is transmitted to an A/D converter 310 (an A/D converter for R1 310a, an AD converter for R2310b, an A/D converter for R3 310c, an A/D converter for R4 310d), and is converted into a digital signal indicating contact detection. The digitized signal is transmitted to a control unit 320, and as a set of collected signals as the sensor element group, the information which the signals hold is stored in a storage unit 330. Thereafter, the signal is sent out to the serial interface unit, and the interrupt handler, and after the signal is converted into a signal which can be read by the touch sensor driver in the interrupt handler, the signal after conversion is input into the queue. The control unit 320 detects the direction at the point of time when it detects contact in the two or more adjacent sensor elements on the basis of the information stored in the storage unit 330.

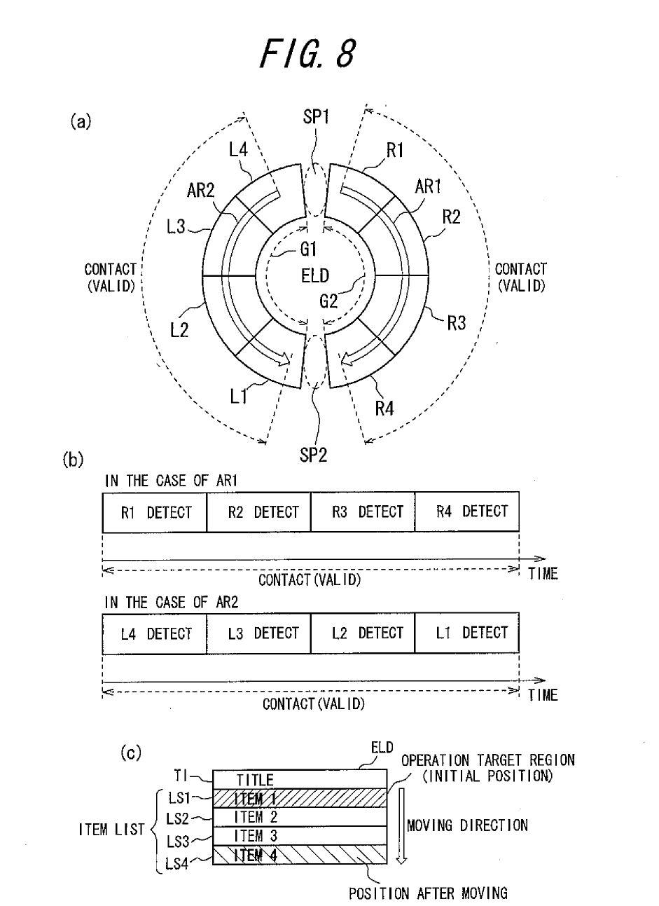

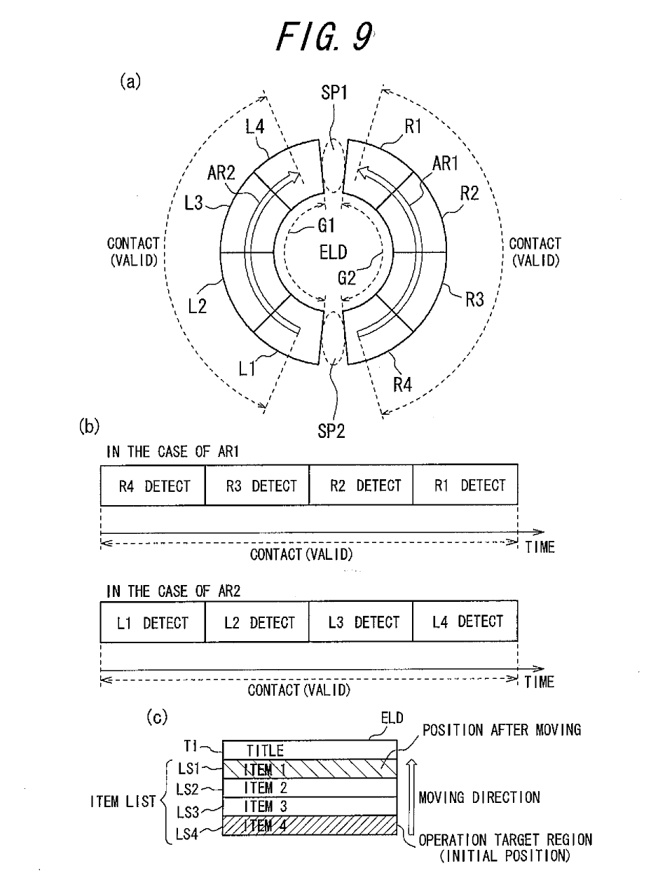

Hereinafter, FIGS. 8 and 9 are diagrams explaining the response of the sub display unit in the case of a user tracing the sensor elements. In each of FIGS. 8 and 9, (a) is a schematic view showing only the sub display unit mounted on the cellular phone terminal, and sensor elements placed side by side along the periphery of it for simplification of the explanation, (b) is a diagram showing the sensor elements which are detected with a lapse of time, and (c) is a diagram showing the positional change of the operation target region of the sub display unit ELD corresponding to the detected sensor elements. In (a) of each of these drawings, the same reference numerals and characters as in FIG. 2 (b) are assigned to the sensor elements, the sensor element groups and the separation sections. Further, in the display of the sub display unit ELD of (c), TI denotes a title of the item list displayed by the sub display unit, and LS1 to LS4 denote the selection candidate items (for example, some lines capable of being scrolled). Further, in the sub display unit of (c), for the item in the state of being the operation target, the cursor is placed on the item, or the item itself is highlighted by reversing display or the like so that the item can be identified as the present operation target region. In these drawings, the items which are displayed as the operation target regions are shown by being highlighted with hatching applied to them. For convenience of explanation, “moving target” is explained in only the operation target region, but when the item itself is moved (scrolled), the sub display unit is operated on the similar principle.

When the respective elements are continuously traced by using contact means such as a finger, for example, in the downward direction from the top shown by the arrow AR1 in FIG. 8 (a), the control unit detects the contact with the lapse of time shown in (b). In this case, the contact is detected in sequence of the sensor elements R1, R2, R3 and R4. Since the continuous contact from R1 to R4 is detected by the two or more adjacent sensor elements, detection of the direction is performed, and in accordance with the number of times of transferring by the adjacent sensor elements and its direction, the operation target region moves on the list displayed on the sub display unit ELD. In this case, as shown in (c), the operation target region moves by three items downward from the item LS1 at the initial position to the item LS4. The operation target region is expressed by hatching, and the one with small hatching pitches is the initial position, whereas the one with large hatching pitches is the position after moving. Like this, according to the present configuration, “the operation target region” of the sub display unit “moves downward” as “the instruction operation of a finger to the downward direction” of the user, and therefore, the user feels as if the user moved the operation target region at will with his or her own finger. Specifically, the operation feeling as the user intends can be obtained.

Similarly, when the sensor elements are traced in the direction shown by the arrow AR2 in FIG. 8 (a), the sensor elements L4, L3, L2 and L1 out of the respective elements detect the contact in this sequence as shown in (b), and since in this case, the contact transfers by three adjacent sensor elements to the downward direction from the top similarly to the arrow AR1, the operation target region moves by three items downward from the item LS1 to the item LS4 as in (c).

When the sensor elements are traced to the upward direction from the bottom (counterclockwise direction) shown by the arrow AR1 in FIG. 9 (a), the sensor elements R4, R3, R2 and R1 out of the respective sensor elements detect the contact in this sequence as shown in (b). In this case, the contact transfers by three adjacent sensor elements from the bottom to the top, and therefore, the operation target region moves by three items from the item LS4 to the item LS1 to the upward direction as in (c).

Likewise, when the sensor elements are traced in the upward direction from the bottom (clockwise direction) shown by the arrow AR2 in FIG. 9 (a), the sensor elements L1, L2, L3 and L4 out of the respective sensor elements detect the contact in this sequence as shown in (b), and since in this case, the contact transfers by three adjacent sensor elements from the bottom to the top similarly to the arrow AR1, the operation target region moves by three items from the item LS4 to the item LS1 in the upward direction as in (c).

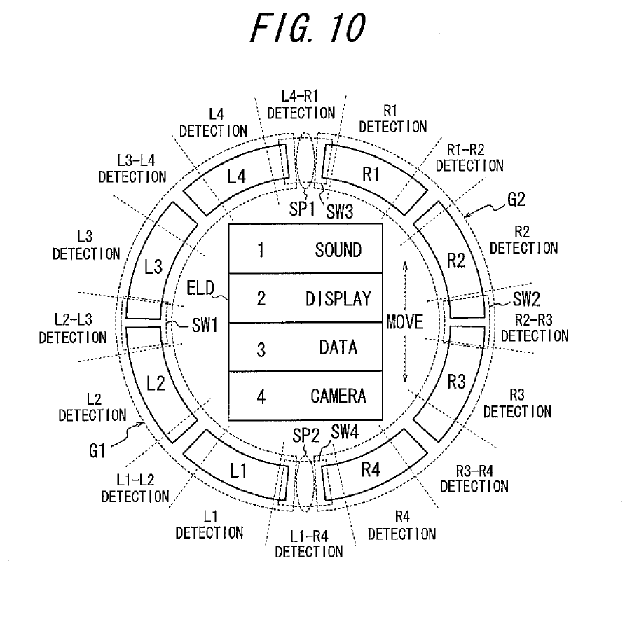

FIG. 10 is a conceptual view showing a sensor element detection state by dividing it into 16 so as to determine not only a single element detection state, but also a plurality of elements detection state further detecting two adjacent elements. FIG. 10 has substantially the same configuration as that of FIG. 5, and in this case, explanation will be made with the configuration in which tact switches are also provided between the first sensor element group G1 and the second sensor element group G2, that is, the configuration in which a tact switch SW3 is provided between the sensor element L4 and the sensor element R1, and a tact switch SW4 is provided between the sensor element R4 and the sensor element L1.

The control unit can manage 16 detection states in total, that are R1-R2 detection, R2-R3 detection, R3-R4 detection, L1-R4 detection, L1-L2 detection, L2-L3 detection, L3-L4 detection and L4-R detection for detecting contact of two adjacent sensor elements in addition to R1 detection, R2 detection, R3 detection, R4 detection, L1 detection, L2 detection, L3 detection and L4 detection for detecting contact of only one sensor element as shown in FIG. 10. In the present invention, more precise control is made possible by providing 16 sensor element detection states so that the single element detection state detecting the operation state of only one sensor element, and the adjacent elements detection state detecting the operation state of the two adjacent sensor elements can be detected.

When the detection state of eight sensor elements is managed one by one, eight detection states can be managed. However, with the eight detection states, the number of states, that is, the state change is small, and therefore, very precise control cannot be performed. Further, in the portable electronic apparatus in which portability is essential, the size itself of the sensor element is small, and therefore, a user sometimes contacts a sensor element across sensor elements. On this occasion, when the contact is detected in sequence of the sensor elements L2 and L3, for example, it means the moving instruction to the upward direction, and there is the fear of bringing about the operation which is not intended by the user. In order to properly process such detection of the contact to the sensor elements, it is necessary to hold fixing of the moving instruction until change in two or three detection states (movement) is detected in the 16 detection states. The processing of holding fixing of the moving instruction will be described in detail with reference to the flowchart.

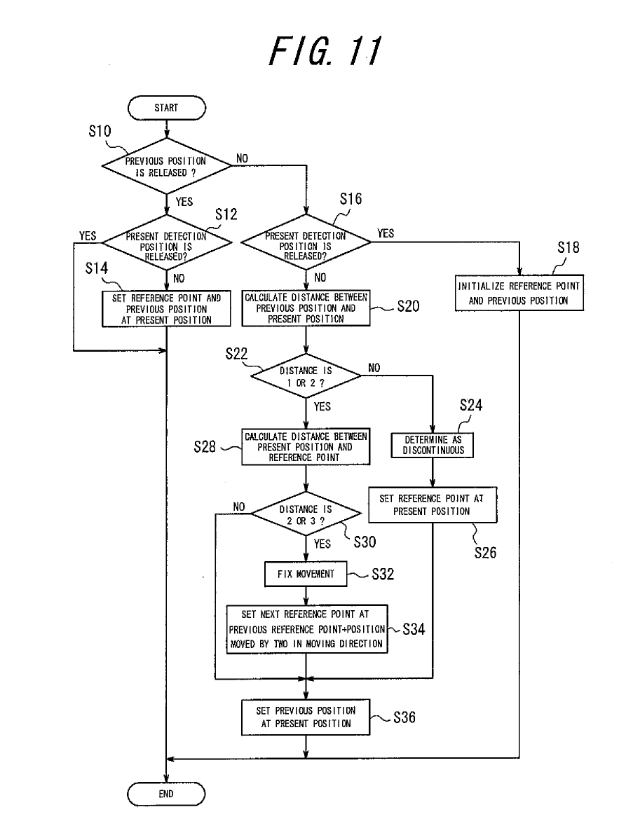

FIG. 11 is a flowchart showing on example of movement fixing processing (namely, holding processing) in the 16 detection states, and each time occurrence of any one of the detection states in the queue QUEUE is detected, the touch sensor driver TSP performs this flowchart processing. The position where the occurrence is first detected from the releases state (any one detection state of 16) is set as the first reference point. From three of the reference point, the present detection position (detection state newly input in the queue QUEUE), the previous detection position (the detection state immediately preceding the one left in the queue QUEUE), the moving distance (transfer of the detection state) is determined. As shown in FIG. 11, in step S10, it is determined whether the previous position is released or not. When it is determined that the previous position is released (the previous data remaining in the queue QUEUE is “release”), the flow goes to step S12, and it is determined whether the present detection position is released or not (specifically, whether the data newly input is “release” or not). When it is determined that the present detection position is released, the processing is finished, whereas when it is determined that it is not released, the flow goes to step S14, and the reference point and the previous detection position are set at the present detection position.

When it is determined that the previous position is not released in step S10 (specifically, when another detection occurs, and the present detection follows it), the flow goes to step S16, and it is determined whether the present detection position is released or not (specifically, whether the newly input signal is “release” or not). When it is determined that the present detection position is released, the reference point and the previous detection position are initialized (cleared), and the processing is finished (step S18). When it is determined that the present detection position is not released in step S16, the distance between the previous detection position and the present detection position is calculated (step S20), and it is determined whether or not the calculated distance is one or two (step S22). When it is determined that the calculated distance is not 1 or 2, it is determined that this is a discontinuous detection state with the sensor element being skipped (step S24), the reference point is set at the present detection position, and the flow goes to step S36. When it is determined that the distance calculated in step S22 is one or two, the distance between the present detection position and the reference point is calculated (step S28). The touch sensor driver TSD performs the calculation of the distance by determining the difference of how many detection states out of 16 detection states is between the previous detection position and the present detection position, since the detection position of each of the sensor elements is known from the signal that is input in the queue QUEUE.

Further, when the distance calculated in step S28 does not satisfy the condition (specifically, four or more) as a result of determining whether or not it is 2 or 3 (step S30), the flow goes to step S36 as an error, and when the condition is satisfied (when the distance is two or three), movement is fixed (step S32). More specifically, the first contact position is set as “reference point”, and when contact continues to be detected successively without being “released” thereafter, “the previous position” is updated. Finally, “movement is present” is determined for the first time when “present position” which is the newest detection position “moves by two or three” with respect to the reference point. Further, by continuously detecting the single element detection state and a plurality of elements detection state, “movement by two” is determined, and therefore, on the sensor elements, a finger moves by the amount of one sensor element for the first time by the aforementioned “movement by two”. The next reference point is set at the position where it moves by two in the moving direction from the previous reference point (step S34), and the flow goes to step S36. In step S36, “the previous detection position” is set at “the present detection position” for the next processing, and the processing is finished.

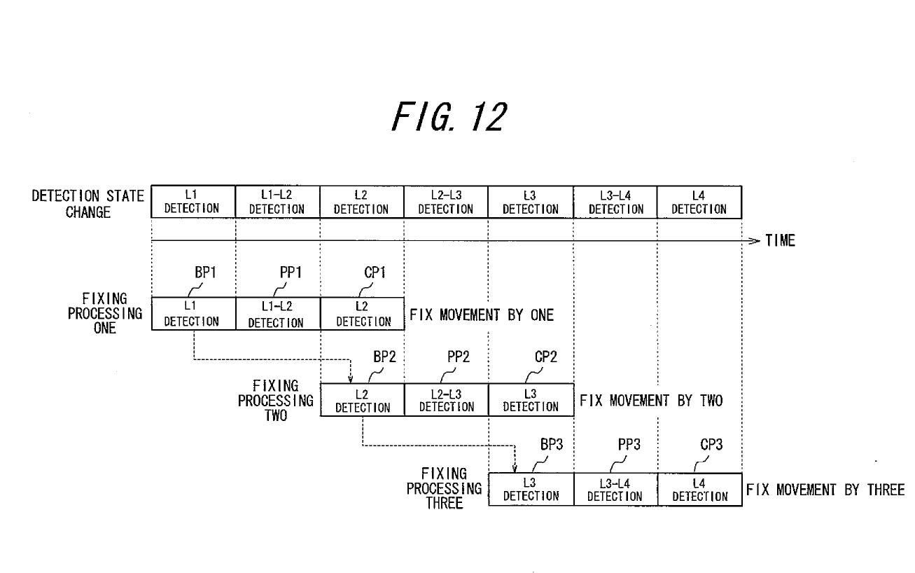

FIG. 12 is a diagram explaining the fixing processing when the processing of the flowchart of FIG. 11 is applied to the contact to the sensor elements L1 to L4 of FIG. 10. As shown in the drawing, change in the detection states is as “L1 detection”, “L1-L2 detection”, “L2 detection”, “L2-L3 detection”, “L3 detection”, “L3-L4 detection”, and “L4 detection”. More specifically, the single element detection state and the plurality of elements detection state are repeatedly detected from L1 to L4. First, the initial “L1 detection” is set at a reference point BP1 (S14). Next, when “L1-L2 detection” occurs, the previous position and the present position detected this time are compared, because the previous position is not release, but “L1 detection” (S22). This is movement by one frame from L1 to L1-L2, and is regarded valid since this satisfies the determination condition of “1 or 2?”, and the reference point and the present position are compared this time (S30). Since the reference point and the previous position are similarly set at L1 in this case, the moving amount is also one frame, movement is not fixed at this stage, and the L1-L2 detections state of the present position is set as the previous position PP1 (S36).

Further, when “L2 detection” occurs without occurrence of “release” halfway, the previous position and the present position CP1 which is detected this time are compared because the previous position is “L1-L2 detection” (S22). This is one-frame movement from L1-L2 to L2, and is regarded as valid, since this satisfies the determination condition of “1 or 2?”, and the reference point and the present position are compared this time (S30). Since the reference point is similarly set at L1 this time without changing from the time of L1 detection, the positional relationship with L2 is two frames, and therefore, the moving amount is determined as two frames. Movement is fixed for the first time here (S32). Subsequently, for the next determination, a reference point BP2 is set at the point which is transferred by two frames in the moving direction from “L1 detection”, that is, “L2 detection” (S34), and the previous position is reset to the present position “L2 detection”, whereby fixing processing 1 is completed (S36).

Like this, movement “1” is determined by the touch sensor driver detecting transfer of the detection states of two frames. More specifically, when movement is fixed in step S32, the component in the moving direction (clockwise direction from L1 to L4) and movement of “1” are stored in the result notification unit NTF, update of the stored content is notified to the base application, and the base application extracts the updated content to notify it to the sub display unit display application AP1 and the like. When the sub display unit display application AP1 is being used, display of the sub display unit ELD is changed as the processing corresponding to this, because the moving amount of “1” is given in “the direction toward the top from the bottom” on the basis of the component in the moving direction. More specifically, when the list display as shown in FIG. 8 (c) is performed, and the operation target region is located at LS4, the operation target region moves to LS3 on the basis of the fixing processing 1. Incidentally, when the detection state transfers continuously to “R4-R3 detection” and “R3 detection” successively from the state of “R4 detection” for R1 to R4 which is the second sensor element group as in the fixing processing 1, the information of “the direction toward the top from the bottom” and addition of the moving amount of “1” is given to the sub display unit display application AP1 on the basis of the component in the moving direction from the touch sensor via the base application, and on the screen display of the list display, the operation target region changes from the item LS4 to LS3 as the operation in the first sensor element group.

Next, the case in which movement of a finger continues without occurrence of “release” following the fixing processing 1 will be described. As in the case of the fixing processing 1, as shown in fixing processing 2 in the drawing, when the detection state proceeds by two frames from a reference point BP2, “L2-L3 detection” is set as the previous position PP2, and “L3 detection” is at the present position CP2, the distance between the reference point BP2 and the present position CP2 becomes two frames, and therefore, movement “1” is further fixed. More specifically, both the fixing processing 2 following the fixing processing 1, and the fixing processing 1, movement of “2” in total is fixed. For the following processing, the reference point is changed with “L3 detection” which is two frames ahead of the reference point BP2 “L2 detection” as a new reference point BP3.

Similarly, as shown in fixing processing 3 in the drawing, the distance becomes two frames at the point of time when the detection state proceeds by two frames from the reference point BP3, “L3-L4 detection” is set as a previous position CP3, and “L4 detection” is at a present position CP3, movement “1” is further fixed, and movement of “three” frames in total with the fixing processing 1 and fixing processing 2 being combined is fixed. Thus, movement of “three” in total is notified to the applications.

As the display in the sub display unit ELD, movement fixing of “1” in “the direction toward the top from the bottom” is notified to the sub display unit display application AP1 twice following the fixing processing 1, and therefore, the operation target region changes to the LS1 which is the position it moves in the upward direction by “2” from the LS3. Here, the moving amount which is fixed by movement of the state transfer by two frames is set as “1” though the detection state is fragmented so that not only the single element detection state but also a plurality of elements detection state is detected, and thereby, movement fixing of “3” at the maximum is performed in the case of the sensor element configured by four sensor elements as in the example as a result. Namely, the moving amount by appearance finally becomes very close to that in the case of performing movement fixing by only the single element detection in the case of four sensor elements, but the moving amount of “3” at the maximum can be ensured even if the user does not accurately touch the surface right on the single element, and the cellular phone terminal can respond to the inaccurate operation of the user in the way corresponding to the desire of the user without being unresponsive.

There is conceivable the case in which when the user carrying the cellular phone performs an operation in the place where vibration easily occurs, his or her finger is instantly off the touch sensor due to external vibration during his or her finger is moving. In such a case, omission of detection hardly occurs in the rough detection method which detects movement by performing only the single element detection that detects only the amount of the number of sensor elements, but when the precise detection method which detects not only the single element detection state but also the plurality of elements detection state is adopted, there is conceivable the case in which even when the finger is instantly off, one detection state is omitted because the finger is continuing a rotating operation. However, by adopting “the distance between the previous position and the present position is 1 or 2?” in step S22, when the position is moved by two from the previous position, that is, even when one is omitted from the previous position, the detection state can be dealt as the continuous movement detection state, and therefore, the operation can be brought as close as possible to the operation desired by the user even under vibration.

Since not only the distance of two frames but also that of three frames is made valid in step S30, the moving operation can be detected when it is detected with a finger being instantly off due to vibration, or one detection state being skipped by a quick operation. Further, in detection of the moving amount of three frames, not only the moving amount of “1” is fixed as in the next two frames, but also setting of the reference point for the next detection is performed by moving only two frames with respect to the previous reference point as when moving by two frames. Therefore, even when movement fixing by detecting three frames is performed, the amount of fixing movement by “n−1” that is obtained by subtracting one from the number of sensor elements n can be ensure, and the user can obtain stable operation feeling which is the same operation feeling no matter how the user may touch the sensor elements.

As described above, in the present invention, the single element detection state detecting the operation state for only one of a plurality of sensor elements, and the adjacent elements detection state detecting the operation states of two adjacent sensor elements out of a plurality of sensor elements are detected, and by combination of the single element detection state and the adjacent elements detection state, movement is determined, whereby the operation feeling as intended by the user can be obtained, and more precise movement detection can be performed without modifying the apparatus. Further, a malfunction caused by touching two different points at the same time can be prevented, and error detection caused by simply touching a point or influence of noise or the like can be prevented.

Further, when five or more selection items are displayed on the screen and detection is performed with only four elements, in order to select the lowermost stage of the selection items, a finger has to be traced over the upper element to the lower element several times, but in the present invention, the number of times of tracing can be decreased by giving the moving amount of two frames at the maximum with two elements, for example. More specifically, the present invention can be also used for the purpose of providing many kinds of movement parameters with a small number of sensor elements.

The present invention is described based on the drawings and embodiment, but attention should be paid to that a person skilled in the art easily makes various modifications and corrections on the basis of the present disclosure. Accordingly, it should be noted that these modifications and corrections are included in the range of the present invention. For example, the functions or the like included in each of the members, each means and each of the steps can be rearranged so as not to be logically inconsistent, and a plurality of means, steps and the like can be combined into one, or divided. For example, the embodiment is described with the sensor element layout provided in a circular form, but the sensor element group placed in a U-shape may be placed to be opposed to each other with the display unit therebetween. Further, the embodiment with the sensor element groups being laterally placed is described, but the sensor element groups may be configured by two vertical groups. Further, the embodiment is described by citing the cellular phone terminal, but the present invention can be widely applied to portable electronic apparatuses such as the portable radio terminals other than a telephone, PDA (personal digital assistance), a portable game machine, a portable audio player, a portable video player, a portable electronic dictionary, and a portable electronic book viewer. Further, in the embodiment, the electrostatic capacitance type contact sensor is cited as the sensor element but the sensor elements of the aforementioned thin film resistor type, an optical type which detects contact by variation in the amount of received light, a SAW type which detects contact by attenuation of a surface acoustic wave, and an electromagnetic induction type which detects contact by occurrence of an induced current may be used. Further, depending on the type of the contact sensor, an indication tool such as a special pen other than a finger is used, and the principle of the present invention can be applied to the portable electronic apparatuses mounted with such contact sensors.

Further, in the above described embodiment, the operation state of the two adjacent sensor elements out of a plurality of sensor elements is detected. However, the present invention is not limited to such a case. For example, the present invention is applicable to the case in which the operation state of a plurality of sensor elements (at least two or more sensor elements) out of a plurality of sensor elements is detected.

More specifically, in this case, the present invention includes a plurality of sensor elements continuously arranged, and a control unit monitoring the operation state of the plurality of sensor element, in which the control unit is capable of detecting a single element detection state detecting an operation state in one sensor element out of the plurality of sensor elements, and a plurality of elements detection state detecting an operation state in a plurality of sensor elements out of the plurality of sensor elements, and determines an operation state by combination of the single element detection state and a plurality of elements detection state.

In the embodiment with such a configuration, for example, after the operation state of a single element is detected, if the operation of another sensor element is detected in addition to the single element, it can be detected that the operation in the direction of the added element is performed. In this case, the number of items by which movement is performed on the items displayed on the display, for example, may be set as one, or may correspond to the number of sensors from the position of the single element originally detected to the added element.

Further, in the embodiment with such a configuration, for example, when the operation state of a single element is detected, and thereafter, the operation of a plurality of sensor elements other than the single element is detected, it can be detected that the operation in the direction of the added elements is performed.

In this case, the number of items by which movement is performed and which are displayed on the display, for example, may be set as one, or may correspond to the number of sensors from the position of a single element originally detected to any of the elements which is added.

### CROSS REFERENCE TO RELATED APPLICATION

The present application is based upon and claims the benefit of priority from the prior Japanese Patent Application No. 2006-229465 (filed on Aug. 25, 2006); the entire contents of which are incorporated herein by reference.

1. A portable electronic apparatus comprising a plurality of sensor elements continuously and adjacently arranged, and a control unit monitoring operation states of the plurality of sensor elements,
characterized in that
the control unit is capable of detecting a single element detection state detecting an operation state in one sensor element out of the plurality of sensor elements, and an adjacent elements detection state detecting an operation state in two adjacent sensor elements out of the plurality of sensor elements, and determines an operation state by combination of the single element detection state and the adjacent elements detection state.

2. The portable electronic apparatus according to claim 1, characterized in that
when the control unit detects that a detection state transfers from the adjacent elements detection state by both a first sensor element and a second sensor element adjacent to the first sensor element to the single element detection state by only the first sensor element, the control unit determines that an operation with movement in a direction to the first sensor element from the second sensor element occurs.

3. The portable electronic apparatus according to claim 1, characterized in that
when the control unit detects that a detection state transfers from the single element detection state by only a first sensor element to the adjacent elements detection state by both the first sensor element and a second sensor element adjacent to the first sensor element, the control unit determines that an operation with movement in a direction to the second sensor element from the first sensor element occurs.

4. The portable electronic apparatus according to claim 1, characterized in that
when the control unit detects that a detection state transfers from the single element detection state by only a first sensor element to the adjacent elements detection state by both the first sensor element and a second sensor element adjacent to the first sensor element, and further detects the single element detection state by only the second sensor element, the control unit determines that an operation with movement in a direction to the second sensor element from the first sensor element occurs.

5. The portable electronic apparatus according to claim 1, characterized in that
when the control unit detects that a detection state transfers from the adjacent elements detection state by both a first sensor element and a second sensor element adjacent to the first sensor element to the single element detection state by only the second sensor element, and further detects the adjacent elements detection state by both the second sensor element and a third sensor element adjacent to the second sensor element, the control unit determines that an operation with movement in a direction to the third sensor element from the first sensor element through the second sensor element occurs.

6. The portable electronic apparatus according to claim 1, characterized in that
when the number of state transfers of the single element detection state and adjacent elements detection state is one or two in the same direction which is an arranging direction of the sensor elements, and the number of transfers from a first detection state is two or three, the control unit determines that an operation with movement occurs to the sensor elements in the same direction which is the arranging direction of the sensor elements.

7. The portable electronic apparatus according to claim 1, characterized in that
the sensor elements are arranged continuously and adjacently in a circular form.

8. An input operation determining method comprising:
the step of monitoring an input operation state of a plurality of sensor elements continuously and adjacently arranged, and detecting a single element detection state detecting an operation state in one sensor element out of the plurality of sensor elements, and an adjacent elements detection state detecting an operation state in two adjacent sensor elements out of the plurality of sensor elements; and
the step of determining an operation state by combination of the single element detection state and the adjacent elements detection state.

9. A portable electronic apparatus, comprising a plurality of sensor elements continuously arranged, and a control unit monitoring an operation state of the plurality of sensor elements,
characterized in that
the control unit is capable of detecting a single element detection state detecting an operation state in one sensor element out of the plurality of sensor elements, and a plurality of elements detection state detecting an operation state in a plurality of sensor elements out of the plurality of sensor elements, and determines an operation state by combination of the single element detection state and the plurality of elements detection state.
